(19) United States
(12) Patent Application Publication
(10) Pub. No.: US 2017/0280193 A1
(43) Pub. Date: Sep. 28, 2017

(54) METHOD AND DEVICE FOR PROCESSING A STREAMING MEDIA FILE

(71) Applicants: Le Holdings(Beijing)Co., Ltd., Beijing (CN); LE SHI ZHI XIN ELECTRONIC TECHNOLOGY (TIAN JIN) LIMITED, Tianjin (CN)

(72) Inventor: Tao Wang, Tianjin (CN)

(21) Appl. No.: 15/247,762

(22) Filed: Aug. 25, 2016

Related U.S. Application Data
(63) Continuation of application No. PCT/CN2016/088978, filed on Jul. 6, 2016.

(30) Foreign Application Priority Data
Mar. 28, 2016 (CN) 201610183604.3

(51) Int. Cl. H04N 21/4425; H04N 21/472; H04N 21/2187; H04N 21/845; H04N 21/234

(52) U.S. Cl. CPC H04N 21/4425; H04N 21/8456; H04N 21/23418; H04N 21/2187; H04N 21/47202

(57) ABSTRACT

Disclosed are a method and apparatus for processing a streaming media file. The method includes: for each slice, obtaining a length of time of the slice recorded in a slice time length field of the slice to be processed; determining play time of a last frame of the slice to be processed, and play time of a first frame of a next slice; judging whether such an abnormal judgment condition is satisfied that the recorded length of time of the slice is different from the real length of time of the slice to be processed, and/or the time difference between the play time of the first frame, and the play time of the last frame is not the average play length of time of each frame; and if so, then determining that the streaming media file is being played abnormally.

### CROSS REFERENCE TO RELATED APPLICATIONS

This application is a continuation of International Application No. PCT/CN2016/088978, filed on Jul. 6, 2016, which is based on and claims the benefit of Chinese Patent Application No. 201610183604.3, filed with the Chinese Patent Office on Mar. 28, 2016 and entitled “Method and apparatus for processing a streaming media file”, which is hereby incorporated by reference in its entirety.

### TECHNICAL FIELD

The present disclosure relates to the field of streaming media, and particularly to a method and device for processing a streaming media file.

### BACKGROUND

A streaming media file has become information indispensable to our living and working. A video file is needed for both video on demand and live video. The streaming media file includes a number of slices, a field describing slice lengths of time of the respective slices, etc. Moreover the respective slices of the streaming media file include respective frames, their corresponding display timestamp information, etc. For example, a video file can include an m3u8 file and a slice, where the m3u8 file includes the #EXTINF field recording the slice length of time of the slice, and the slice includes the respective frames, their corresponding display timestamp information, etc.

As there are more and more streaming media providers, there are also more and more generated streaming media files. The inventors have identified during making of the disclosure that some streaming media file may have a degraded quality. For example, the length of time of a slice may be different from the real length of time thereof, and there may be also an error in the display timestamp thereof. If there is an error in either of them, then the streaming media file may be played abnormally (for example, the streaming media file may not be played or may be interrupted). There has been absent in the prior art a solution to detect the length of time of a slice and the display timestamp information of a slice for an error, so that the streaming media file generated with a poor quality in the prior art, thus resulting in the problem of abnormal playing thereof.

### SUMMARY

Embodiments of the disclosure provide a method and apparatus for processing a streaming media file so as to address the problem in the prior art that there has been absent a solution to detect the length of time of a slice and the presentation timestamp information of a slice for an error so that the streaming media file generated with a poor quality in the prior art, thus resulting in the problem of abnormal playing thereof.

Some embodiments of the disclosure provide a method for processing a streaming media file, the method includes:

at an electronic device,

for each slice to be processed of the streaming media file, obtaining a length of time of the slice recorded in a slice time length field of the slice to be processed;

determining play time of a last frame of the slice to be processed, and play time of a first frame of a next slice to the slice to be processed, according to a play time reference of the slice to be processed;

judging whether such an abnormal judgment condition is satisfied that the recorded length of time of the slice is different from a real length of time of the slice to be processed, and/or a time difference between the play time of the first frame, and the play time of the last frame is not an average play length of time of each frame; and

if the abnormal judgment condition is satisfied, then determining that the streaming media file is being played abnormally.

Some embodiments of the disclosure provide an electronic device, comprising:

at least one processor; and

a memory communicably connected with the at least one processor for storing instructions executable by the at least one processor, wherein execution of the instructions by the at least one processor causes the at least one processor to:

for each slice to be processed of the streaming media file, obtain a length of time of the slice recorded in a slice time length field of the slice to be processed;

determine play time of a last frame of the slice to be processed, and play time of a first frame of a next slice to the slice to be processed, according to a play time reference of the slice to be processed;

judge whether such an abnormal judgment condition is satisfied that the recorded length of time of the slice is different from the real length of time of the slice to be processed, and/or a time difference between the play time of the first frame, and the play time of the last frame is not an average play length of time of each frame; and

determine that the streaming media file is being played abnormally, if a result of the judgment indicates the abnormal judgment condition is satisfied.

Some embodiments of the disclosure provide a non-transitory computer-readable storage medium storing executable instructions that, when executed by an electronic device with a touch-sensitive display, cause the electronic device to:

for each slice to be processed of the streaming media file, obtain a length of time of the slice recorded in a slice time length field of the slice to be processed;

determine play time of a last frame of the slice to be processed, and play time of a first frame of a next slice to the slice to be processed, according to a play time reference of the slice to be processed;

judge whether such an abnormal judgment condition is satisfied that the recorded length of time of the slice is different from a real length of time of the slice to be processed, and/or a time difference between the play time of the first frame, and the play time of the last frame is not an average play length of time of each frame; and

if the abnormal judgment condition is satisfied, determine that the streaming media file is being played abnormally.

Advantageous effects of the embodiments of the disclosure are as follows: in the technical solutions according to the embodiments of the disclosure, for each slice to be processed of the streaming media file, the length of time of the slice recorded in a slice time length field of the slice to be processed is obtained, play time of a last frame of the slice to be processed, and play time of a first frame of a next slice to the slice to be processed are determined according to a play time reference of the slice to be processed; it is judged whether such an abnormal judgment condition is satisfied that the recorded length of time of the slice is different from the real length of time of the slice to be processed, and/or the time difference between the play time of the first frame, and the play time of the last frame is not the average play length of time of each frame; and if so, then it will be determined that the streaming media file is being played abnormally. Thus in the embodiments of the disclosure, if the recorded length of time of the slice is different from the real length of time of the slice to be processed, then this will indicate that the length of time of the slice is incorrect so that the slice may be played abnormally. If the time difference between the play time of the first frame, and the play time of the last frame is not the average play length of time of each frame, then this will indicate that the play length of time between the last frame of the slice to be processed, and the first frame of the next slice is more than two frames, but only one of the frames of images is played, which indicates that there may be an error in a presentation timestamp of the first frame of the next slice to the slice to be processed, so that the slice may be interrupted while being played, thus resulting in abnormal playing thereof. Accordingly in the embodiments of the disclosure, the length of time of the slice and/or the presentation timestamp can be detected for an error to thereby judge whether the streaming media file will be played abnormally. Furthermore a user can know conveniently which streaming media file may be played abnormally to thereby process the abnormal streaming media file so as to improve the quality of playing for the user, and also the quality of the generated streaming media file.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is an exemplary flow chart of a method for processing a streaming media file in accordance with some embodiments.

FIG. 2 is an exemplary flow chart of a method for processing a streaming media file in accordance with some embodiments of the disclosure;

FIG. 3 is a schematic structural diagram of an apparatus for processing a streaming media file in accordance with some embodiments of the disclosure; and

FIG. 4 is a schematic structural diagram of a device for processing a streaming media file in accordance with some embodiments of the disclosure;

FIG. 5 is a schematic structural diagram of an electronic device in accordance with some embodiments of the disclosure.

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

In the embodiments of the disclosure, for each slice to be processed of the streaming media file, the length of time of the slice recorded in a slice time length field of the slice to be processed is obtained, the play time of a last frame of the slice to be processed, and the play time of a first frame of a next slice to the slice to be processed are determined according to a play time reference of the slice to be processed; it is judged whether such an abnormal judgment condition is satisfied that the recorded length of time of the slice is different from the real length of time of the slice to be processed, and/or the time difference between the play time of the first frame, and the play time of the last frame is not the average play length of time of each frame; and if so, then it will be determined that the streaming media file is being played abnormally. Thus in the embodiments of the disclosure, if the recorded length of time of the slice is different from the real length of time of the slice to be processed, then this will indicate that the length of time of the slice is incorrect so that the slice may be played abnormally. If the time difference between the play time of the first frame, and the play time of the last frame is not the average play length of time of each frame, then this will indicate that the play length of time between the last frame of the slice to be processed, and the first frame of the next slice is more than two frames, but only one of the frames of images is played, which indicates that there may be an error in a presentation timestamp of the first frame of the next slice to the slice to be processed, so that the slice may be interrupted while being played, thus resulting in abnormal playing thereof. Accordingly in the embodiments of the disclosure, the length of time of the slice and/or the presentation timestamp can be detected for an error to thereby judge whether the streaming media file may be played abnormally. Furthermore a user can know conveniently which streaming media file may be played abnormally to thereby process the abnormal streaming media file so as to improve the quality of playing for the user, and also the quality of the generated streaming media file.

The method for processing a streaming media file according to the embodiment of the disclosure will be further described in the following embodiments.

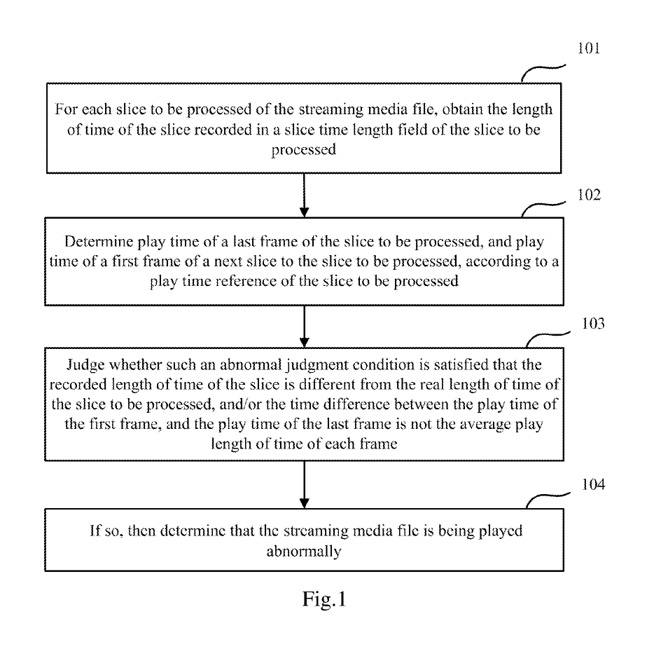

As illustrated in FIG. 1 which is an exemplary flow chart of a method for processing a streaming media file according to a first embodiment of the disclosure, the method includes the following steps:

The step 101 is, for each slice to be processed of the streaming media file, to obtain the length of time of the slice recorded in a slice time length field of the slice to be processed.

The step 102 is to determine play time of a last frame of the slice to be processed, and play time of a first frame of a next slice to the slice to be processed, according to a play time reference of the slice to be processed.

Here the step 101 and the step 102 can be performed in any order.

The step 103 is to judge whether such an abnormal judgment condition is satisfied that the length of time of the slice recorded is different from the real length of time of the slice to be processed, and/or the time difference between play time of the first frame, and play time of the last frame is not the average play length of time of each of the frames;

Here the average play length of time of each of frames refers to the average play length of time of one frame, which can be the average play length of time of one frame of the slice to be processed. For example, if the play length of time of the slice to be processed is T, and the number of frames is S, then the average play length of time of each frame may be T divided S. This method for calculating the average play length of time of each frame is particularly applicable to a streaming media file with a variable frame ratio, but also can be applicable to a streaming media file with an invariable frame ratio. For a streaming media file with an invariable frame ratio, the average play length of time of each frame can alternatively be obtained as the total play length of time of the streaming media file divided by the total number of frames of the streaming media file. In a particular embodiment, any method in which the average play length of time of each of the frames of the slice to be processed can be obtained will be applicable to the embodiment of the disclosure, so the embodiment of the disclosure will not be limited thereto; and

The step 104 is, if so, to determine that the streaming media file is being played abnormally.

In some embodiments of the disclosure, if the recorded length of time of the slice is different from the real length of time of the slice to be processed, then this may indicate that the length of time of the slice is incorrect so that the slice may be played abnormally. If the time difference between the play time of the first frame, and play time of the last frame is not the average play length of time of each frame, then this may indicate that the play length of time between the last frame of the slice to be processed, and the first frame of the next slice is more than two frames, but only one of the frames of images is played, which indicates that there may be an error in a presentation timestamp of the first frame of the next slice, so that the slice may be interrupted while being played, thus resulting in abnormal playing thereof. Accordingly in the embodiments of the disclosure, the length of time of the slice and/or the presentation timestamp can be detected for an error to thereby judge whether the streaming media file may be played abnormally. Thus a user can know conveniently which streaming media file may be played abnormally to thereby process the abnormal streaming media file so as to improve the quality of playing for the user, and also the quality of the generated streaming media file.

Moreover the embodiment of the disclosure can further alleviate the streaming media file from being played abnormally to thereby improve the quality of playing thereof; and can further generate information about error in a length of time of slice, or a presentation timestamp. For the sake of further understanding, the method above will be further described below.

1. It is judged whether the recorded length of time of the slice is the same as the real length of time.

In some embodiments, in order to judge accurately whether the recorded length of time of the slice is the same as the real length of time of the slice, in some embodiments of the disclosure, it can be judged as follows whether the recorded length of time of the slice is the same as the real length of time of the slice to be processed in the step A1 to the step A5:

The step A1 is to determine play time of a first frame and play time of the last frame of the slice to be processed, according to the play time reference of the slice to be processed;

The step A2 is to calculate the length of time between the play time of the first frame and the play time of the last frame of the slice to be processed;

The step A3 is to judge whether the length of time is equal to the recorded length of time of the slice;

The step A4 is, if so, to determine that the recorded length of time of the slice is the same as the real length of time of the slice to be processed; and

The step A5 is, if not, to determine that the recorded length of time of the slice is different from the real length of time of the slice to be processed.

2. The streaming media file is alleviated from being played abnormally

In some embodiments of the disclosure, the streaming media file can be alleviated from being played abnormally, as follows to thereby improve the quality of playing the streaming media file. Particularly the streaming media file typically further includes a varying encoding characteristic identifier describing whether an encoding characteristic varies between preceding and succeeding slices (e.g., the #EXT-X-DISCONTINUITY in the m3u8 file is a varying encoding characteristic identifier). If the encoding characteristic does not vary between the preceding and succeeding slices, then a presentation timestamp of a frame to be played can be incremented constantly, that is, the play time of the first frame of the succeeding slice will be more than the play time of the last frame of the preceding slice. Thus in some embodiments of the disclosure, the quality of playing the video can be improved as follows:

1) If the recorded length of time of the slice to be processed is different from the real length of time of the slice to be processed, and if the streaming media file is played based on the length of time of the slice, then the streaming media file may be played abnormally. In some embodiments of the disclosure, the streaming media file can be alleviated from being played abnormally due to an error in the length of time of the slice, as follows in the step B1 to the step B4 to thereby improve the quality of playing the streaming media file:

The step B1 is to determine there is a varying encoding characteristic identifier between the slice to be processed, and the next slice to the slice to be processed;

The step B2 is, if not, to judge whether the play time of the first frame of the next slice to the slice to be processed is more than the play time of the last frame of the slice to be processed.

If there is a varying encoding characteristic identifier between the slice to be processed, and the next slice to the slice to be processed, then the next slice will be determined as a new slice to be processed, and the flow will return to the step 101 until all the slices of the streaming media file are processed.

Since it has been determined that the recorded length of time of the slice to be processed is different from the real length of time of the slice to be processed, a reasonable play time reference can be determined taking into account a presentation timestamp (i.e., play time) of the first frame of the next slice to the slice to be processed, particularly as described in the step B3 and the step B4.

The step B3 is, if the play time of the first frame of the next slice to the slice to be processed is more than the play time of the last frame of the slice to be processed, to determine the play time of the first frame of the next slice, as a play time reference of a succeeding slice to the slice to be processed;

If the play time of first frame of the next slice is more than the play time of the last frame of the slice to be processed, then this will indicate that the presentation timestamp of the first frame of the next slice to the slice to be processed is correct, so that the play time of the first frame of the next slice of the slice to be processed will be determined as a play time reference of a succeeding slice to the slice to be processed, to thereby alleviate the streaming media file from being played abnormally so as to improve the quality of playing thereof; and

The step B4 is, if the play time of first frame of the next slice to the slice to be processed is less than the play time of the last frame play of the slice to be processed, to determine the sum of the play time of last frame of the slice to be processed, and the average play length of time of each of the frames as a play time reference of a succeeding slice to the slice to be processed.

If the play time of the first frame of the next slice to the slice to be processed is less than the play time of the last frame of the slice to be processed, then the sum of the play time of the last frame of the slice to be processed, and the average play length of time of each frame will be determined as a play time reference of a succeeding slice to the slice to be processed, to thereby alleviate the streaming media file from being played abnormally so as to improve the quality of playing thereof.

Thus in the embodiment of the disclosure, if it is determined that there is an error in the recorded length of time of slice, then a play time reference of a succeeding slice to the slice to be processed will be replaced so that the play time of the succeeding slice to the slice to be processed will not be calculated from the incorrect length of time of the slice, to thereby avoid the slice from being played abnormally due the incorrect length of time of the slice so as to improve the quality of playing thereof.

2) If the recorded length of time of the slice is the same as the real length of time of the slice to be processed, then if there is an error in the presentation timestamp of the next slice to the slice to be processed, then the slice may also be played abnormally. For example, if the play time of the first frame of the next slice precedes the play time of last frame of the slice to be processed, then the slice will be played abnormally. Thus in some embodiments of the disclosure, the streaming media file can be alleviated from being played abnormally due to the incorrect presentation timestamp, as follows in the step C1 to the step C3 to thereby improve the quality of playing the streaming media file.

The step C1 is to judge whether there is a varying encoding characteristic identifier between the slice to be processed, and the next slice;

Here if there is a varying encoding characteristic identifier between the slice to be processed, and the next slice, then the next slice will be determined as a new slice to be processed, and the flow will return to the step 101 until all the slices of the streaming media file are processed;

The step C2 is, if there is not a varying encoding characteristic identifier between the slice to be processed, and the next slice, to judge whether such a condition is satisfied that the play time of the first frame of the next slice is more than the play time of the last frame of the slice to be processed, and the time difference between the play time of the first frame of the next slice, and the play time of the last frame of the slice to be processed is the average play length of time of each frame;

For example, if the play time of the first frame of the next slice of the slice to be processed is A, the play time of the last frame of the slice to be processed is B, and the average play length of time of each frame is C, then it will be determined in the step C2 whether such a condition is satisfied that A is more than B, and A−B=C. If not, which indicates that A is not more than B, and/or A−B≠C, then the slice will be played abnormally, so the flow will proceed to the step C3 of resetting a play time reference to thereby avoid the slice from being played abnormally due to the abnormal presentation timestamp of the first frame of the next slice so as to improve the quality of playing thereof; and

The step C3 is, if so, to determine the sum of the play time of the last frame of the slice to be processed, and the average play length of time of each frame as a play time reference of a succeeding slice to the slice to be processed.

In some embodiments, if it is determined that the play time of the first frame of the next slice to the slice to be processed is more than the play time of the last frame of the slice to be processed, and more than the average play length of time of each frame, then this will indicate that the slice is being played normally instead of being played abnormally, so the slice can be further played using the play time reference of the slice to be processed.

In some embodiments, if the play time of the first frame of the next slice to the slice to be processed is less than the play time of the last frame of the slice to be processed, then it will indicate that there is an error in the presentation timestamp of the next slice to the slice to be processed. In some embodiments of the disclosure, in order to further improve an instruction of the streaming media file, information indicating an error in the presentation timestamp of the next slice of the slice to be processed can be further generated so that the user can know from the information which slice of the streaming media file has an error in the presentation timestamp thereof to thereby modify the presentation timestamp of the slice accurately and conveniently so as to improve the quality of the generated streaming media file.

In some embodiments, if the recorded length of time of the slice is different from the real length of time of the slice to be processed, then it will indicate that the recorded length of time of the slice does not agree with the real length of time, and in some embodiments of the disclosure, the information indicating an error in the recorded length of time of the slice to be processed can be further generated so that the user can know from the information which slice of the streaming media file has an error in the length of time of the slice thereof to thereby modify the presentation timestamp of the slice accurately and conveniently so as to improve the quality of the generated streaming media file.

In summary, in the embodiments of the disclosure, it can be determined which streaming media file may be played abnormally so that the user can know conveniently and take action to correct the error in the streaming media file to thereby improve the quality of playing the streaming media file. Moreover in some embodiments of the disclosure, the play time reference can be determined again to thereby alleviate in effect the streaming media file from being played abnormally so as to improve the quality of playing the streaming media file. The corresponding error information can be further generated for the error in the length of time of the slice, or the error in the presentation timestamp so that the user can locate the streaming media file in which the error occurs, and modify the error to thereby improve the quality of the generated streaming media file.

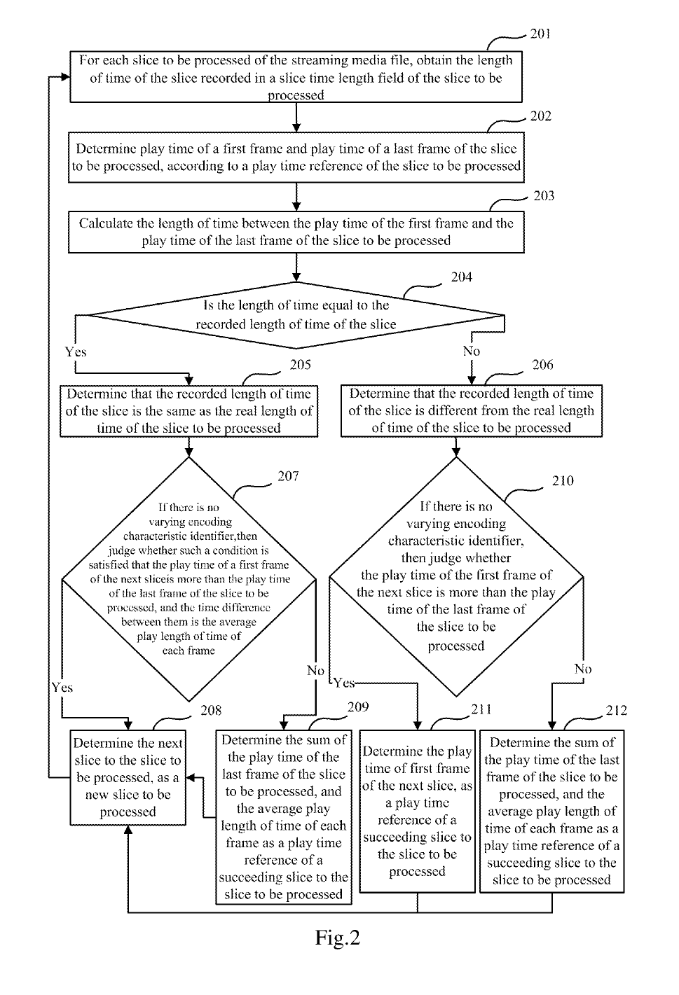

For the sake of further understanding, the method for processing a streaming media file according to the embodiment of the disclosure will be further described. An executor of the method can be a player or a server. Particularly as illustrated in FIG. 2 which is a schematic flow chart of the method, the method includes the following steps:

The step 201 is, for each slice to be processed of the streaming media file, to obtain the length of time of the slice recorded in a slice time length field of the slice to be processed.

The step 202 is to determine play time of a first frame and play time of a last frame of the slice to be processed, according to a play time reference of the slice to be processed.

The step 203 is to calculate the length of time between the play time of the first frame and the play time of the last frame of the slice to be processed.

The step 204 is to judge whether the length of time is equal to the recorded length of time of the slice, and if so, then flow will proceed to the step 205; otherwise, the flow will proceed to the step 206.

The step 205 is to determine that the recorded length of time of the slice is the same as the real length of time of the slice to be processed, and thereafter the flow proceeds to the step 207.

The step S206 is to determine that the recorded length of time of the slice is different from the real length of time of the slice to be processed, and thereafter the flow proceeds to the step 210.

After the step 206, information indicating an error of the recorded length of time of the slice to be processed can be further generated (that is, one slice time length error can be recorded);

The step S207 is, if there is no varying encoding characteristic identifier between the slice to be processed, and the next slice, then it will be judged whether such a condition is satisfied that play time of the first frame of the next slice is more than the play time of the last frame of the slice to be processed, and the time difference between the play time of the first frame of the next slice, and the play time of the last frame of the slice to be processed is the average play length of time of each frame; and if so, then the flow will proceed to the step 208; otherwise, the flow will proceed to the step 209.

The step 208 is to determine the next slice to the slice to be processed, as a new slice to be processed, and the flow will proceed to the step 201.

The step 209 is to determine the sum of the play time of the last frame of the slice to be processed, and the average play length of time of each frame as a play time reference of a succeeding slice to the slice to be processed, and thereafter the flow proceeds to the step 208.

In some embodiments, if the result of the judgment is negative, and it is determined that the play time of the first frame of the next slice to the slice to be processed is less than the play time of the last frame of the slice to be processed, then information indicating an error in a presentation timestamp of the next slice to the slice to be processed can be further generated (that is, one timestamp error can be recorded).

The step 210 is, if there is no varying encoding characteristic identifier between the slice to be processed, and the next slice, to judge whether the play time of the first frame of the next slice to the slice to be processed is more than the play time of the last frame of the slice to be processed, and if so, then the flow will proceed to the step 211; otherwise, the flow will proceed to the step 212.

If the result of the judgment in the step 210 is negative, then information indicating an error in a presentation timestamp of the next slice to the slice to be processed can be further generated (that is, one timestamp error can be recorded);

The step 211 is to determine the play time of the first frame of the next slice to be processed to the slice to be processed, as a play time reference of a succeeding slice to the slice to be processed, and thereafter the flow proceeds to the step 208.

The step 212 is to determine the sum of the play time of the last frame of the slice to be processed, and the average play length of time of each frame as a play time reference of a succeeding slice to the slice to be processed, and thereafter the flow will proceed to the step 208.

Thus in the embodiment of the disclosure, it can be determined which streaming media file may be played abnormally so that the user can know conveniently and take action to correct the error in the streaming media file to thereby improve the quality of playing the streaming media file. Moreover in some embodiments of the disclosure, the play time reference can be determined again to thereby alleviate in effect the streaming media file from being played abnormally so as to improve the quality of playing the streaming media file. The corresponding error information can be further generated for the error in the length of time of the slice, or the error in the presentation timestamp so that the user can locate the streaming media file in which the error occurs, and modify the error to thereby improve the quality of the generated streaming media file.

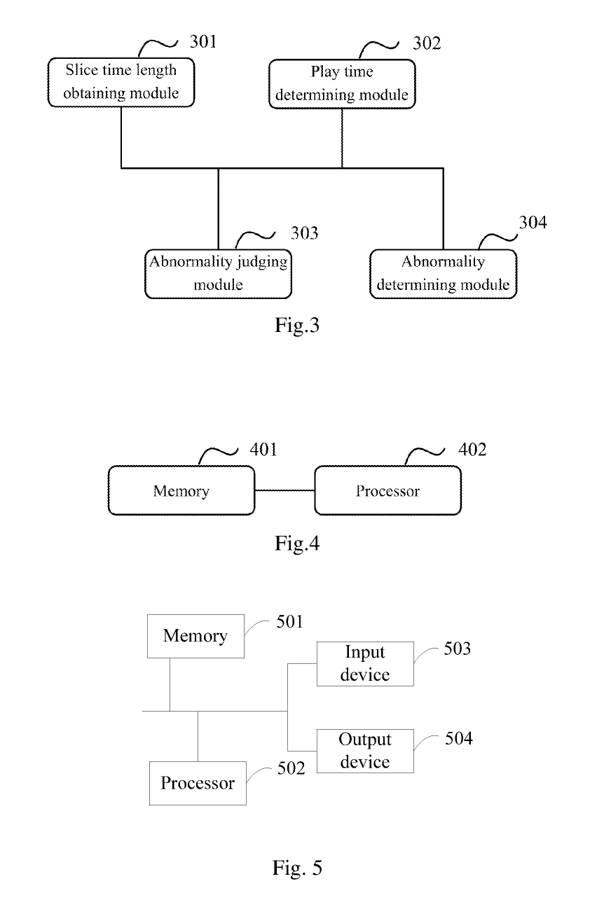

Based upon the same inventive idea, some embodiments of the disclosure further provide an apparatus for processing a streaming media file as illustrated in FIG. 3 which is a schematic structural diagram of the apparatus including:

A slice time length obtaining module 301 is configured, for each slice to be processed of the streaming media file, to obtain the length of time of the slice recorded in a slice time length field of the slice to be processed;

A play time determining module 302 is configured to determine play time of a last frame of the slice to be processed, and play time of a first frame of a next slice to the slice to be processed, according to a play time reference of the slice to be processed;

An abnormality judging module 303 is configured to judge whether such an abnormal judgment condition is satisfied that the recorded length of time of slice is different from the real length of time of the slice to be processed, and/or the time difference between the play time of the first frame, and the play time of the last frame is not the average play length of time of each frame; and

An abnormality determining module 304 is configured to determine that the streaming media file is being played abnormally, if a result of the judgment by the abnormality judging module is positive.

In some embodiments of the disclosure, if the recorded length of time of the slice is different from the real length of time of the slice to be processed, then the apparatus further includes:

A first varying characteristic identifier judging module is configured to judge whether there is a varying encoding characteristic identifier between the slice to be processed, and the next slice to the slice to be processed;

A first judging module is configured, if a result of the judgment by the first varying characteristic identifier judging module is negative, to judge whether the play time of the first frame of the next slice to the slice to be processed is more than the play time of the last frame of the slice to be processed;

A first reference adjusting module is configured, if a result of the judgment by the first judging module is positive, to determine the play time of the first frame of the next slice to the slice to be processed, as a play time reference of a succeeding slice to the slice to be processed; and

A second reference adjusting module is configured, if the result of the judgment by the first judging module is negative, to determine the sum of the play time of the last frame of the slice to be processed, and the average play length of time of each frame as a play time reference of a succeeding slice to the slice to be processed.

In some embodiments, if the recorded length of time of the slice is the same as the real length of time of the slice to be processed, then the apparatus will further include:

A second varying characteristic identifier judging module is configured to judge whether there is a varying encoding characteristic identifier between the slice to be processed, and the next slice to the slice to be processed;

A second judging module is configured, if a result of the judgment by the second varying characteristic identifier judging module is negative, to determine whether such a condition is satisfied that the play time of the first frame of the next slice to the slice to be processed is more than the play time of the last frame of the slice to be processed, and the time difference between the play time of the first frame of the next slice to the slice to be processed, and the play time of the last frame of the slice to be processed is the average play length of time of each frame; and

A third reference adjusting module is configured, if the result of the judgment by the second judging module is negative, to determine the sum of the play time of the last frame of the slice to be processed, and the average play length of time of each frame as a play time reference of a succeeding slice to the slice to be processed.

In some embodiments, if the play time of the first frame of the next slice to the slice to be processed is less than the play time of the last frame of the slice to be processed, then the apparatus further includes:

A first information generating module is configured to generate information indicating an error in a presentation timestamp of the next slice to the slice to be processed.

In some embodiments, the apparatus further includes:

A time length judging module configured to judge whether the recorded length of time of the slice is the same as the real length of time of the slice to be processed, being configured:

To determine play time of the first frame and play time of the last frame of the slice to be processed, according to the play time reference of the slice to be processed;

To calculate the length of time between the play time of the first frame and the play time of the last frame of the slice to be processed;

To judge whether the length of time is equal to the recorded length of time of the slice; and

If so, to determine that the recorded length of time of the slice is the same as the real length of time of the slice to be processed;

Otherwise, to determine that the recorded length of time of the slice is different from the real length of time of the slice to be processed.

In some embodiments, if the recorded length of time of the slice is different from the real length of time of the slice to be processed, then the apparatus further includes:

A second information generating module is configured to generate information indicating an error in the recorded length of time of the slice to be processed.

In summary, with the apparatus for processing a streaming media file according to the embodiments of the disclosure, if the recorded length of time of the slice is different from the real length of time of the slice to be processed, then this may indicate that the length of time of the slice is incorrect so that the slice may be played abnormally; and if the time difference between the play time of the first frame, and the play time of the last frame is not the average play length of time of each frame, then this may indicate that the play length of time between the last frame of the slice to be processed, and the first frame of the next slice is more than two frames, but only one of the frames of images is played, which indicates that there may be an error in a presentation timestamp of the first frame of the next slice to the slice to be processed, so that the slice may be interrupted while being played, thus resulting in abnormal playing thereof. Accordingly in the embodiments of the disclosure, the length of time of the slice and/or the presentation timestamp can be detected for an error to thereby judge whether the streaming media file may be played abnormally, so that a user can know conveniently which streaming media file may be played abnormally to thereby process the abnormal streaming media file so as to improve the quality of playing for the user, and also the quality of the generated streaming media file.

Based upon the same inventive idea, some embodiments of the disclosure further provide a device for processing a streaming media file as illustrated in FIG. 4, which is a schematic structural diagram of the device, the device includes:

A memory 401 is configured to store various program and instructions;

A processor 402 is configured to execute the various program and instructions stored in the memory to perform the operations of:

For each slice to be processed of the streaming media file, obtaining the length of time of the slice recorded in a slice time length field of the slice to be processed;

Determining play time of a last frame of the slice to be processed, and play time of a first frame of a next slice to the slice to be processed, according to a play time reference of the slice to be processed;

Judging whether such an abnormal judgment condition is satisfied that the recorded length of time of the slice is different from the real length of time of the slice to be processed, and/or the time difference between the play time of the first frame, and the play time of the last frame is not the average play length of time of each frame; and

If the abnormal judgment condition is satisfied, then determining that the streaming media file is being played abnormally.

In some embodiments of the disclosure, if the recorded length of time of the slice is different from the real length of time of the slice to be processed, then the processor may be further configured:

To judge whether there is a varying encoding characteristic identifier between the slice to be processed, and the next slice to the slice to be processed; and

If there is not the varying encoding characteristic identifier between the slice to be processed, and the next slice to the slice to be processed, to judge whether the play time of the first frame of the next slice to the slice to be processed is more than the play time of the last frame of the slice to be processed, and

If the play time of the first frame of the next slice to the slice to be processed is more than the play time of the last frame of the slice to be processed, to determine the play time of the first frame of the next slice to the slice to be processed, as a play time reference of a succeeding slice to the slice to be processed,

If the play time of the first frame of the next slice to the slice to be processed is less than the play time of the last frame of the slice to be processed, to determine a sum of the play time of the last frame of the slice to be processed, and the average play length of time of each frame as a play time reference of a succeeding slice to the slice to be processed.

In some embodiments, if the recorded length of time of the slice is the same as the real length of time of the slice to be processed, then the processor may be further configured:

To judge whether there is a varying encoding characteristic identifier between the slice to be processed, and the next slice to the slice to be processed;

If there is not the varying encoding characteristic identifier between the slice to be processed, and the next slice to the slice to be processed, to determine whether such a condition is satisfied that the play time of the first frame of the next slice to the slice to be processed is more than the play time of the last frame of the slice to be processed, and the time difference between the play time of the first frame of the next slice to the slice to be processed, and the play time of the last frame of the slice to be processed is the average play length of time of each frame; and

Otherwise, to determine the sum of the play time of the last frame of the slice to be processed, and the average play length of time of each frame as a play time reference of a succeeding slice to the slice to be processed.

In some embodiments, if the play time of the first frame of the next slice to the slice to be processed is less than the play time of the last frame of the slice to be processed, then the processor will be further configured to generate information indicating an error in a presentation timestamp of the next slice to the slice to be processed.

In some embodiments, the processor further configured to judge whether the recorded length of time of the slice is the same as the real length of time of the slice to be processed is further configured:

To determine play time of a first frame and the play time of the last frame of the slice to be processed, according to the play time reference of the slice to be processed;

To calculate the length of time between the play time of the first frame and the play time of the last frame of the slice to be processed;

To judge whether the length of time is equal to the recorded length of time of the slice;

If the length of time is equal to the recorded length of time of the slice, to determine that the recorded length of time of the slice is the same as the real length of time of the slice to be processed; and

Otherwise, to determine that the recorded length of time of the slice is different from the real length of time of the slice to be processed.

In some embodiments, if the recorded length of time of the slice is different from the real length of time of the slice to be processed, then the processor will be further configured to generate information indicating an error in the recorded length of time of the slice to be processed.

Based upon the same inventive idea, some embodiments of the disclosure further provide an electronic device as illustrated in FIG. 5, which is a schematic structural diagram of the device, the device includes: one or more processors 502 and a memory 501. FIG. 5 takes an example of one processor 502.

The electronic device further includes an input device 503 and an output device 504.

The processor 502 and the memory 501 can be connected together by a bus of other connections. The FIG. 4 takes an example of bus connection.

The memory 501 serves as a non-transitory computer-readable storage medium for storing non-transitory programs, non-transitory computer-executable instructions and modules, such as some modules for performing the method for processing a streaming media file according to some embodiments of the disclosure (e.g. units as shown in FIG. 3). The processor 502 performs the method for processing a streaming media file according to some embodiments of the disclosure by executing the non-transitory programs, instructions and modules.

The memory 501 can have a program-storing partition and a data-storing partition. Here the program-storing partition can store operation systems, at least one application for performing a certain function. The data-storing partition can store data generated by operation of the apparatus. Further, the memory 501 can be high-speed RAM, and also non-transitory memory, such as at least one magnetic disk memory device, flash memory or any other non-transitory solid memory device. In some embodiments, the memory 501 can be a remote memory which is arranged in a manner that is away from the processor 502. The remote memories can connected to the electronic device via network, of which instances include but not limit to internet, intranet, LAN, mobile radio communications and combination thereof.

The input device 503 can receive inputted digital or character information, and generate signal inputs concerning user setup and function control of the apparatus. The output device 504 can be display screen and other display devices.

At least one of the modules is stored in the memory 501. When at least one of the modules is executed by the at least one processor 502, it performs the aforementioned method for closing a terminal.

The aforementioned electronic device can execute the method according to some embodiments of the disclosure, and has functional modules for executing corresponding method and advantageous thereof. For more technical details, the method according to some embodiments of the disclosure can be referred.

The electronic device is in multiple forms, which include but not limit to:

1. Mobile communication device, of which characteristic has mobile communication function, and briefly acts to provide voice and data communication. These terminals include smart pone (i.e. iPhone), multimedia mobile phone, feature phone, cheap phone and etc.

2. Ultra mobile personal computing device, which belongs to personal computer, and has function of calculation and process, and has mobile networking function in general. These terminals include PDA, MID, UMPC (Ultra Mobile Personal Computer) and etc.

3. Portable entertainment equipment, which can display and play multimedia contents. These equipments include audio player, video player (e.g. iPod), handheld game player, electronic book, hobby robot and portable vehicle navigation device.

4. Server, which provides computing services, and includes processor, hard disk, memory, system bus and etc. The framework of the server is similar to the framework of universal computer, however, there is a higher requirement for processing capacity, stability, reliability, safety, expandability, manageability and etc due to supply of high reliability services.

5. Other electronic devices having data interaction function.

Moreover some embodiments of the disclosure further provide a computer program including computer readable codes which are executed on a device to cause the device to perform the method for processing a streaming media file according to any one of the embodiments above of the disclosure.

Moreover some embodiments of the disclosure further provide a computer readable medium on which the computer program is stored.

In summary, with the method and apparatus for processing a streaming media file according to the embodiments of the disclosure, if the recorded length of time of the slice is different from the real length of time of the slice to be processed, then this will indicate that the length of time of the slice is incorrect so that the slice may be played abnormally; and if the time difference between the play time of the first frame, and the play time of the last frame is not the average play length of time of each frame, then this will indicate that the play length of time between the last frame of the slice to be processed, and the first frame of the next slice is more than two frames, but only one of the frames of images is played, which indicates that there may be an error in a presentation timestamp of the first frame of the next slice to the slice to be processed, so that the slice may be interrupted while being played, thus resulting in abnormal playing thereof. Accordingly in the embodiments of the disclosure, the length of time of the slice and/or the presentation timestamp can be detected for an error to thereby judge whether the streaming media file may be played abnormally, so that a user can know conveniently which streaming media file may be played abnormally to thereby process the abnormal streaming media file so as to improve the quality of playing for the user, and also the quality of the generated streaming media file.

The embodiments of the apparatus described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the disclosure. This can be understood and practiced by those ordinarily skilled in the art without any inventive effort.

Those skilled in the art can clearly appreciate from the foregoing description of the embodiments that the embodiments of the disclosure can be implemented in software plus a necessary general hardware platform or, of course, in hardware, although the former implementation is preferred in many cases. Based upon such understanding, the technical solutions of the embodiments of the disclosure in essence or the part thereof contributing to the prior art can be embodied in the form of a software product which can be stored in a storage medium and which includes several instructions to cause a terminal device (e.g., a mobile phone, a personal computer, a server, a network device, etc.) to perform the methods according to the respective embodiments of the disclosure.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. A method for processing a streaming media file, the method comprises:
at an electronic device:
for each slice to be processed of the streaming media file, obtaining a length of time of the slice recorded in a slice time length field of the slice to be processed;
determining play time of a last frame of the slice to be processed, and play time of a first frame of a next slice to the slice to be processed, according to a play time reference of the slice to be processed;
judging whether such an abnormal judgment condition is satisfied that the recorded length of time of the slice is different from a real length of time of the slice to be processed, and/or a time difference between the play time of the first frame, and the play time of the last frame is not an average play length of time of each frame; and
if the abnormal judgment condition is satisfied, determining that the streaming media file is being played abnormally.

2. The method according to claim 1, wherein if the recorded length of time of the slice is different from the real length of time of the slice to be processed, then the method further comprises:
judging whether there is a varying encoding characteristic identifier between the slice to be processed, and the next slice to the slice to be processed; and
if there is not the varying encoding characteristic identifier between the slice to be processed, and the next slice to the slice to be processed, judging whether the play time of the first frame of the next slice to the slice to be processed is more than the play time of the last frame of the slice to be processed, and
if the play time of the first frame of the next slice to the slice to be processed is more than the play time of the last frame of the slice to be processed, then determining the play time of the first frame of the next slice to the slice to be processed, as a play time reference of a succeeding slice to the slice to be processed, and
if the play time of the first frame of the next slice to the slice to be processed is less than the play time of the last frame of the slice to be processed, determining a sum of the play time of the last frame of the slice to be processed, and the average play length of time of each frame as the play time reference of a succeeding slice to the slice to be processed.

3. The method according to claim 1, wherein if the recorded length of time of the slice is the same as the real length of time of the slice to be processed, then the method further comprises:
judging whether there is a varying encoding characteristic identifier between the slice to be processed, and the next slice to the slice to be processed;
if there is not the varying encoding characteristic identifier between the slice to be processed, and the next slice, determining whether such a condition is satisfied that the play time of the first frame of the next slice to the slice to be processed is more than the play time of the last frame of the slice to be processed, and the time difference between the play time of the first frame of the next slice to the slice to be processed, and the play time of the last frame of the slice to be processed is the average play length of time of each frame; and
if the condition is not satisfied, determining a sum of the play time of the last frame of the slice to be processed, and the average play length of time of each frame as a play time reference of a succeeding slice to the slice to be processed.

4. The method according to claim 2, wherein if the play time of the first frame of the next slice to the slice to be processed is less than the play time of the last frame of the slice to be processed, then the method further comprises:
generating information indicating an error in a presentation timestamp of the next slice to the slice to be processed.

5. The method according to claim 1, wherein judging whether the recorded length of time of the slice is the same as the real length of time of the slice to be processed comprises:
determining play time of a first frame and the play time of the last frame of the slice to be processed, according to the play time reference of the slice to be processed;
calculating a length of time between the play time of the first frame and the play time of the last frame of the slice to be processed;
judging whether the length of time is equal to the recorded length of time of the slice; and
if the length of time is equal to the recorded length of time of the slice, then determining that the recorded length of time of the slice is the same as the real length of time of the slice to be processed;
if the length of time is not equal to the recorded length of time of the slice, determining that the recorded length of time of the slice is different from the real length of time of the slice to be processed.

6. The method according to claim 1, wherein if the recorded length of time of the slice is different from the real length of time of the slice to be processed, then the method further comprises:
generating information indicating an error in the recorded length of time of the slice to be processed.

7. An electronic device, comprising:
at least one processor; and
a memory communicably connected with the at least one processor for storing instructions executable by the at least one processor, wherein execution of the instructions by the at least one processor causes the at least one processor to:
for each slice to be processed of the streaming media file, obtain a length of time of the slice recorded in a slice time length field of the slice to be processed;
determine play time of a last frame of the slice to be processed, and play time of a first frame of a next slice to the slice to be processed, according to a play time reference of the slice to be processed;
judge whether such an abnormal judgment condition is satisfied that the recorded length of time of the slice is different from a real length of time of the slice to be processed, and/or a time difference between the play time of the first frame, and the play time of the last frame is not an average play length of time of each frame; and
if the abnormal judgment condition is satisfied, determine that the streaming media file is being played abnormally.

8. The device according to claim 7, wherein if the recorded length of time of the slice is different from the real length of time of the slice to be processed, then execution of the instructions by the at least one processor causes the at least one processor further to:
judge whether there is a varying encoding characteristic identifier between the slice to be processed, and the next slice to the slice to be processed; and
if there is not the varying encoding characteristic identifier between the slice to be processed, and the next slice to the slice to be processed, judge whether the play time of the first frame of the next slice to the slice to be processed is more than the play time of the last frame of the slice to be processed, and
if the play time of the first frame of the next slice to the slice to be processed is more than the play time of the last frame of the slice to be processed, determine the play time of the first frame of the next slice to the slice to be processed, as a play time reference of a succeeding slice to the slice to be processed,
if the play time of the first frame of the next slice to the slice to be processed is less than the play time of the last frame of the slice to be processed, determine a sum of the play time of the last frame of the slice to be processed, and the average play length of time of each frame as the play time reference of a succeeding slice to the slice to be processed.

9. The device according to claim 7, wherein if the slice length of time of the slice is the same as the real length of time of the slice to be processed, then execution of the instructions by the at least one processor causes the at least one processor to:
judge whether there is a varying encoding characteristic identifier between the slice to be processed, and the next slice to the slice to be processed;
if there is not the varying encoding characteristic identifier between the slice to be processed, and the next slice, determine whether such a condition is satisfied that the play time of the first frame of the next slice to the slice to be processed is more than the play time of the last frame of the slice to be processed, and the time difference between the play time of the first frame of the next slice to the slice to be processed, and the play time of the last frame of the slice to be processed is the average play length of time of each frame; and
if the condition is not satisfied, determine a sum of the play time of the last frame of the slice to be processed, and the average play length of time of each frame as a play time reference of a succeeding slice to the slice to be processed.

10. The device according to claim 8, wherein execution of the instructions by the at least one processor causes the at least one processor to:
if the play time of the first frame of the next slice to the slice to be processed is less than the play time of the last frame of the slice to be processed, generate information indicating an error in a presentation timestamp of the next slice to the slice to be processed

11. The device according to claim 7, wherein while judging whether the recorded length of time of the slice is the same as the real length of time of the slice to be processed, execution of the instructions by the at least one processor causes the at least one processor to:
determine play time of a first frame and the play time of the last frame of the slice to be processed, according to the play time reference of the slice to be processed;
calculate a length of time between the play time of the first frame and the play time of the last frame of the slice to be processed;
judge whether the length of time is equal to the recorded length of time of the slice; and
if the length of time is equal to the recorded length of time of the slice, determine that the recorded length of time of the slice is the same as the real length of time of the slice to be processed;
if the length of time is not equal to the recorded length of time of the slice, determine that the recorded length of time of the slice is different from the real length of time of the slice to be processed.

12. The device according to claim 7, wherein execution of the instructions by the at least one processor causes the at least one processor to:
if the recorded length of time of the slice is different from the real length of time of the slice to be processed, generate information indicating an error in the recorded length of time of the slice to be processed.

13. A non-transitory computer-readable storage medium storing executable instructions that, when executed by an electronic device with a touch-sensitive display, cause the electronic device to:
for each slice to be processed of the streaming media file, obtain a length of time of the slice recorded in a slice time length field of the slice to be processed;
determine play time of a last frame of the slice to be processed, and play time of a first frame of a next slice to the slice to be processed, according to a play time reference of the slice to be processed;
judge whether such an abnormal judgment condition is satisfied that the recorded length of time of the slice is different from a real length of time of the slice to be processed, and/or a time difference between the play time of the first frame, and the play time of the last frame is not an average play length of time of each frame; and
if the abnormal judgment condition is satisfied, determine that the streaming media file is being played abnormally.

14. The non-transitory computer-readable storage medium according to claim 13, wherein the computer readable codes cause the device further to:
if the recorded length of time of the slice is different from the real length of time of the slice to be processed, judge whether there is a varying encoding characteristic identifier between the slice to be processed, and the next slice to the slice to be processed;
if there is not the varying encoding characteristic identifier between the slice to be processed, and the next slice to the slice to be processed, judge whether the play time of the first frame of the next slice to the slice to be processed is more than the play time of the last frame of the slice to be processed, and
if the play time of the first frame of the next slice to the slice to be processed is more than the play time of the last frame of the slice to be processed, determine the play time of the first frame of the next slice to the slice to be processed, as a play time reference of a succeeding slice to the slice to be processed, and
if the play time of the first frame of the next slice to the slice to be processed is less than the play time of the last frame of the slice to be processed, determine a sum of the play time of the last frame of the slice to be processed, and the average play length of time of each frame as the play time reference of a succeeding slice to the slice to be processed.

15. The non-transitory computer-readable storage medium according to claim 13, wherein the computer readable codes cause the device further to:
if the recorded length of time of the slice is the same as the real length of time of the slice to be processed, judge whether there is a varying encoding characteristic identifier between the slice to be processed, and the next slice to the slice to be processed;
if there is not the varying encoding characteristic identifier between the slice to be processed, and the next slice, determine whether such a condition is satisfied that the play time of the first frame of the next slice to the slice to be processed is more than the play time of the last frame of the slice to be processed, and the time difference between the play time of the first frame of the next slice to the slice to be processed, and the play time of the last frame of the slice to be processed is the average play length of time of each frame; and
if the condition is not satisfied, determine a sum of the play time of the last frame of the slice to be processed, and the average play length of time of each frame as a play time reference of a succeeding slice to the slice to be processed.

16. The non-transitory computer-readable storage medium according to claim 14, wherein the computer readable codes cause the device further to:
if the play time of the first frame of the next slice to the slice to be processed is less than the play time of the last frame of the slice to be processed, generate information indicating an error in a presentation timestamp of the next slice to the slice to be processed.

17. The non-transitory computer-readable storage medium according to claim 13, wherein while judging whether the recorded length of time of the slice is the same as the real length of time of the slice to be processed, the computer readable codes cause the device further to:
determine play time of a first frame and the play time of the last frame of the slice to be processed, according to the play time reference of the slice to be processed;
calculate a length of time between the play time of the first frame and the play time of the last frame of the slice to be processed;
judge whether the length of time is equal to the recorded length of time of the slice; and
if the length of time is equal to the recorded length of time of the slice, then determine that the recorded length of time of the slice is the same as the real length of time of the slice to be processed;
if the length of time is not equal to the recorded length of time of the slice, determine that the recorded length of time of the slice is different from the real length of time of the slice to be processed.

18. The non-transitory computer-readable storage medium according to claim 13, wherein the computer readable codes cause the device further to:
if the recorded length of time of the slice is different from the real length of time of the slice to be processed, generate information indicating an error in the recorded length of time of the slice to be processed.
